(19) United States
(12) Patent Application Publication
(10) Pub. No.: US 2013/0132713 A1
(43) Pub. Date: May 23, 2013

(54) ELECTRONIC EQUIPMENT, METHOD OF CONTROLLING ELECTRONIC EQUIPMENT AND CONTROL PROGRAM FOR ELECTRONIC EQUIPMENT

(71) Applicant: Tomoyuki Kokubun, Ome-shi (JP)

(72) Inventor: Tomoyuki Kokubun, Ome-shi (JP)

(21) Appl. No.: 13/483,421

(22) Filed: May 30, 2012

(30) Foreign Application Priority Data
Nov. 17, 2011 (JP) 2011-252009

(51) Int. Cl. G06F 9/06

(52) U.S. Cl. 713/2

(57) ABSTRACT

According to one embodiment, an electronic equipment includes: an application configured to operate an electronic equipment, which serves to instruct OS to start based on settings; an OS starting discriminating module configured to discriminate as to whether or not the OS is started based on instruction of start-up of the application; and a white list object discriminating module configured to discriminate whether or not the application is an object of the white list stored in advance when the OS is started based on instruction of start-up of the application, and configured to instruct refusal of access of the application from the OS when the application is not the object of the white list.

### CROSS REFERENCE TO RELATED APPLICATION(S)

The application is based upon and claims the benefit of priority from Japanese Patent Application No. 2011-252009 filed on Nov. 17, 2011, the entire contents of which are incorporated herein by reference.

### BACKGROUND

1. Field

Preferred embodiments of the present invention relate to an electronic equipment, a method of controlling an electronic equipment and a control program for an electronic equipment.

2. Description of the Related Art

In recent years, there have been popularized electronic equipments adapted for requesting authentication at start-up (stat-up authentication) to user with a view to establishing security. As an example of electronic equipments as described above, there are mentioned PCs (Personal Computers), etc.

As the start-up authentication in the above-mentioned electronic equipments, e.g., message to hasten authentication is displayed every time an electronic equipment (computer) is started.

Moreover, as an example of the start-up authentication for electronic equipments, there is mentioned authentication using fingerprint (fingerprint authentication). In this fingerprint authentication, there are realized, for example, PC start-up authentication, and automatic authentication of OS log-on followed by the above-mentioned PC start-up authentication.

Further, in recent years, there are being popularized electronic equipments capable of performing picture recording of broadcasting programs received and/or automatic receptions of mails, etc.

In these electronic equipments, in order to perform pictures recording of broadcasting programs received, automatic receptions of mails, etc., and/or confirmation of updating of news sites, etc., there is performed, e.g., a scheme to set a time to automatically start electronic equipments (perform automatic start-up thereof).

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a view showing an outer appearance of an electronic equipment according to a preferred embodiment.

FIG. 2 is a block diagram showing the configuration of the electronic equipment according to the preferred embodiment.

FIG. 3 is a diagram showing start-up operation of the electronic equipment according to the preferred embodiment.

FIGS. 4A and 4B are diagrams showing an example of a setting screen of application for operating the electronic equipment according to the preferred embodiment.

FIG. 5 is a diagram showing an example of a display screen of automatic start-up refusal which is outputted from the electronic equipment according to the preferred embodiment.

FIG. 6 is a flowchart for explaining the operation of the electronic equipment according to the preferred embodiment.

FIG. 7 is a diagram showing an example of a screen for setting a device to inhibit data input at the electronic equipment according to the preferred embodiment.

FIG. 8 is a flowchart another operation of the electronic equipment according to the preferred embodiment.

### DETAILED DESCRIPTION

According to one embodiment, an electronic equipment includes: an application configured to operate an electronic equipment, which serves to instruct OS to start based on settings; an OS starting discriminating module configured to discriminate as to whether or not the OS is started based on instruction of start-up of the application; and a white list object discriminating module configured to discriminate whether or not the application is an object of the white list stored in advance when the OS is started based on instruction of start-up of the application, and configured to instruct refusal of access of the application from the OS when the application is not the object of the white list.

A preferred embodiment will now be described with reference to the attached drawings.

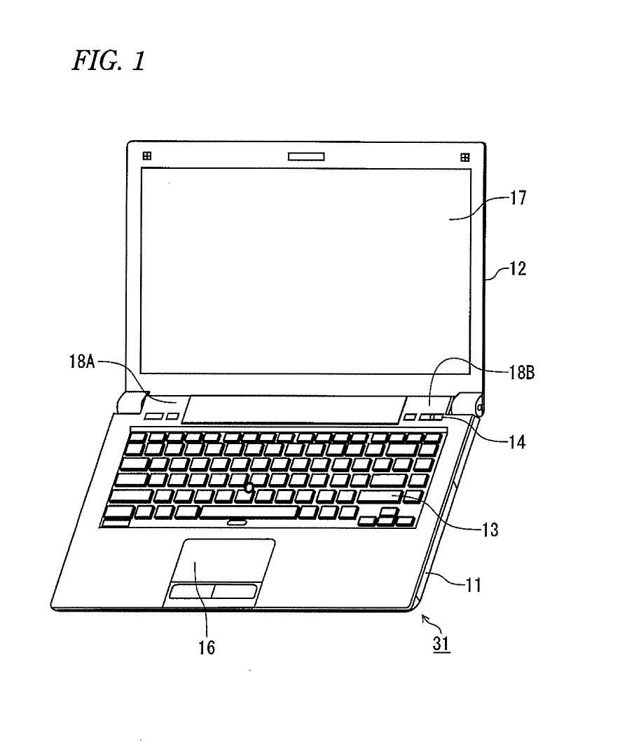

FIG. 1 is a view showing the outer appearance of an electronic equipment according to the preferred embodiment.

In this example, electronic equipment 31 is realized as, e.g., notebook-type personal computer (which will be hereinafter simply referred to as note PC or PC as occasion may demand).

The electronic equipment 31 comprises, e.g., a computer (note PC body) body 11, and a video display module 12. In the video display module 12, there is incorporated, e.g., a LCD (Liquid Crystal Display).

The video display module 12 is attached to the computer (note PC) body 11 in such a manner that it can be rotated between an opening position where the upper face of the computer (note PC) body 11 is exposed and a closed position for covering the upper face of the computer (note PC) body 11.

The computer (note PC) body 11 includes a thin box-shaped casing, wherein there are arranged, on the upper face of the casing, a keyboard 13, a power button 14 for allowing the power supply of the electronic equipment 31 to turn ON/OFF, a touch pad 16, and speakers 18A and 18B, etc.

Moreover, e.g., on the right side face of the computer (note PC) body 11, there is provided a USB connector 19 for connecting USB cable and USB device of the USB (universal serial bus) 2.0 standard.

Further, on the back face of the computer (note PC) body 11, there is provided an external display connection terminal corresponding to, e.g., HDMI (high-definition multimedia interface) standard (not shown). This external display connection terminal is used for outputting a digital video signal to an external display.

Further, although particularly not shown, this electronic equipment 31 is operative to set, e.g., a time to automatically start the electronic equipment in order to perform picture recording of broadcasting programs received, automatic reception of mail, etc., and/or confirmation of updating of news sites, etc.

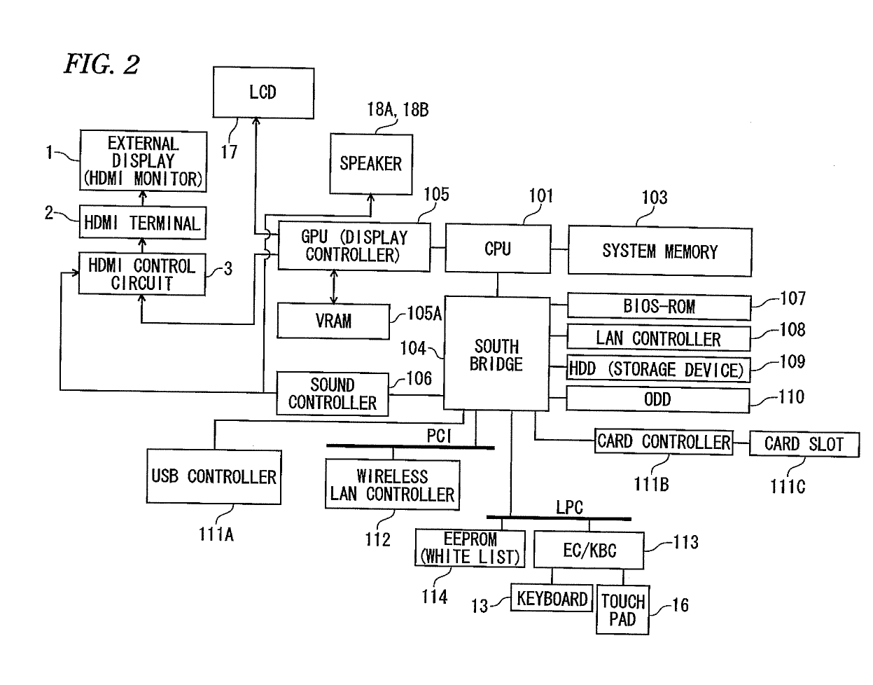

FIG. 2 is block diagram showing the configuration of the electronic equipment according to the embodiment.

The electronic equipment 31 comprises, e.g., as shown in FIG. 2, a CPU (central processing unit) 101, a system memory 103, a south-bridge 104, a GPU (Graphics Processing Unit) 105, a VRAM (video RAM: random access memory) 105A, a sound controller 106, a BIOS-ROM (basic input/output system-read only memory) 107, a LAN (local area network) controller 108, a hard disc drive (HDD) (storage module) 109, an optical disc drive (ODD) 110, a USB controller 111A, a card controller 111B, a card slot 111C, a wireless LAN controller 112, an embedded controller/keyboard controller (EC/KBC) 113, and an EEPROM (electrically erasable programmable ROM) 114, etc.

The CPU 101 is a processor for controlling the operations of the respective components within the electronic equipment 31.

The CPU 101 serves to execute BIOS stored in the BIOS-ROM 107. The BIOS is a program for hardware control. In the CPU 101, there is included a memory controller for performing access control of the system memory 103. Moreover, the CPU 101 includes, e.g., a function to execute communication with the GPU 105 through serial bus of the PCI EXPRESS standard, etc.

The GPU 105 is a display controller for controlling the LCD 17 used as a display monitor of the electronic equipment 31.

A display signal generated by the GPU 105 is sent to the LCD 17. Moreover, the GPU 105 can send also a digital video signal to the external display 1 through the HDMI control circuit 3 and the HDMI terminal 2.

The HDMI terminal 2 is the previously described external display connection terminal. The HDMI terminal 2 can send a non-compressed digital video signal and a non-compressed digital audio signal to the external display 1 like television by way of a single cable. The HDMI control circuit 3 is an interface for sending, through the HDMI terminal 2, the digital video signal to the external display 1 called HDMI monitor.

The south bridge 104 serves to control respective devices on a PCI (Peripheral Component Interconnect) bus and respective devices on the LPC (Low Pin Count) bus. Moreover, the south bridge 104 includes therewithin an IDE (Integrated Drive Electronics) for controlling the HDD 109 and the ODD 110.

Further, the south bridge 104 also has a function to execute communication with the sound controller 106.

The sound controller 106 is a sound source device, and serves to output audio data subject to reproduction to the speakers 18A, 18B and/or the HDMI control circuit 3. The LAN controller 108 is a wire communication device for executing, e.g., wire communication of the IEEE 802.3 standard. On the other hand, the wireless LAN controller 112 is a wireless communication device for executing, e.g., wireless communication of the IEEE 802.11g standard. The USB controller 111A serves to execute, e.g., communication with an external equipment or equipments corresponding to the USB 2.0 standard.

For example, the USB controller 111A is used for receiving image data files stored in a digital camera. Moreover, the card controller 111B serves to execute write and read operations of data with respect to a memory card like SD card, which is inserted into a card slot provided at the computer (note PC) body 11.

The EC/KBC 113 is one chip microcomputer in which the embedded controller for power management, and the keyboard controller for controlling the keyboard 13 and the touch pad 16 are integrated. The EC/KBC 113 has a function to allow the power supply of the electronic equipment 31 to turn ON/OFF in dependency upon an operation of the power button 14 by user.

The display control in this embodiment is performed, e.g., by allowing the CPU 101 to execute programs recorded in or on the system memory 103 or HDD 109, etc.

It is to be noted that “white list” according to this embodiment is stored in advance in the EEPROM 114, e.g., also called flash memory.

The “white list” will now be described.

In this embodiment, the “white list” is a table showing a list of objects free from warning. In this example, as described later, this “white list” is a table indicating a list for discriminating as to whether or not an application for operating the electronic equipment 31 is an object free from warning. Moreover, the application for operating the electronic equipment 31 serves to allow OS to perform start-up instruction based on settings.

Moreover, in this embodiment, the OS is an abbreviation of Operating System.

For example, the OS is a software for providing basic functions utilized commonly from a large number of application softwares, e.g., input/output function such as keyboard input and/or image output, and/or management of disc and/or memory, etc. to perform management of the entirety of the computer system.

In this example, the OS is stored in, e.g., the HDD 109.

Moreover, the above-mentioned “white list” can be also stored in or on the memory or HDD 109 subjected to management by BIOS-ROM.

It is to be noted that the electronic equipment 31 of this embodiment is not limited to the personal computer, but may be applied to TVs (televisions), mobile telephones and/or portable electronic equipments, etc.

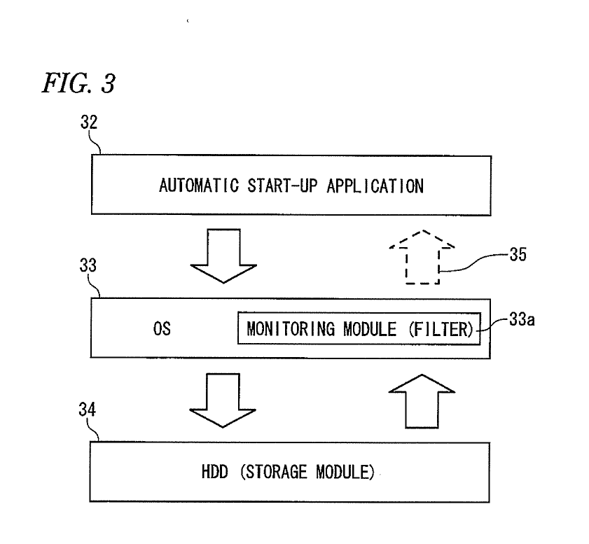

FIG. 3 is a diagram showing start-up operation of the electronic equipment according to the preferred embodiment.

As described above, there is employed, in this embodiment, such a scheme to set, e.g., a time in advance to automatically start the electronic equipment 31 in order to perform picture recording of broad casting programs received and/or automatic receptions of mails, etc., and/or confirmation of updating of news sites, etc.

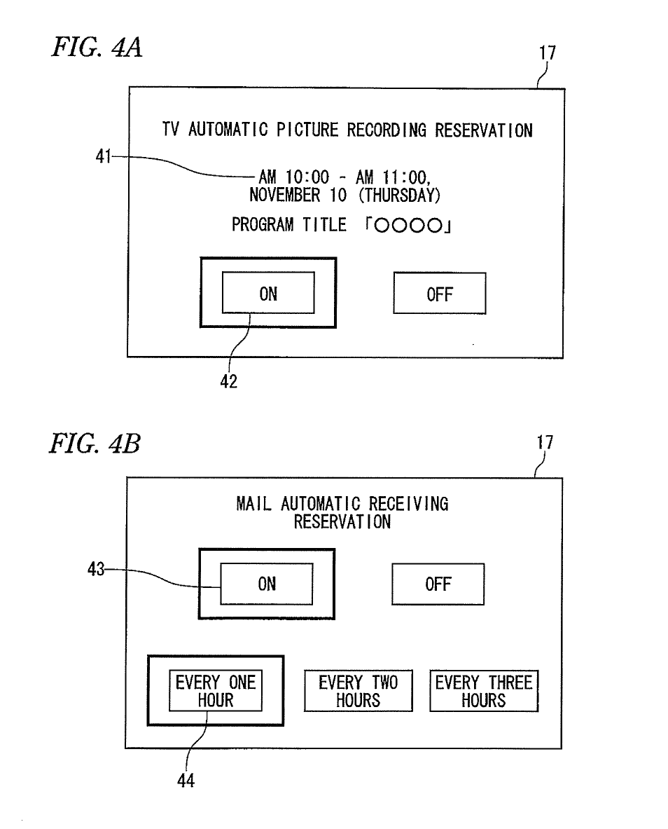

The application for allowing this electronic equipment 31 to perform automatic start-up operation (automatic start-up application) 32 is set in advance as explained below with reference to FIGS. 4A and 4B, and is stored in, e.g., EEPROM (flash memory) 114.

Further, this application is started in a time which is set in advance to instruct the OS 33 stored in the HDD 34 (the above-mentioned HDD 109, etc.) to perform start-up thereof.

Further, in this embodiment, this OS 33 serves to discriminate as to whether or not it is started based on starting instruction of the above mentioned application (automatic starting application) 32.

Such discrimination is performed in, e.g., a monitoring module (filter) 33a controlled by the CPU 101. This monitoring module (filter) 33a is constituted in, e.g., a portion of the above-mentioned OS 33.

Moreover, in this embodiment, in the case where this OS is started based on start-up instruction of the above-mentioned application (automatic start-up application) 32, it serves to discriminate as to whether or not the above-mentioned application (automatic starting application) 32 is an object of the “white list” stored in advance. Such a discrimination is controlled by, e.g., the CPU 101.

In this example, in the case where above-mentioned application (automatic start-up application) 32 is not an object of the “white list”, there is given an instruction to refuse access to the above-mentioned application (automatic start-up application) 32 from the OS 33.

Moreover, in the case where the above-mentioned application (automatic start-up application) 32 is an object of the “white list”, there is given an instruction to permit access to the application (automatic start-up application) 32 from the OS33.

Namely, in this embodiment, in the case where the above-mentioned application (automatic start-up application) 32 is an object of the “white list”, start-up of the application (automatic start-up application) 32 is continued.

FIGS. 4A and 4B are views showing an example of a setting screen of application for operating the electronic equipment according to the preferred embodiment.

FIG. 4A is an example of a setting screen for setting application for picture recording reservation for starting the electronic equipment 31 by the automatic start-up to perform picture recording of broadcasting programs.

This setting screen is displayed on, e.g., the LCD screen of the video display module.

In this example, there are displayed a picture recording reservation date “A.M. 10:00 -A.M. 11:00, November 10 (Thursday), and picture recording program title “oooo” 41.

Moreover, setting of “ON” 42 of picture recording reservation of this broadcasting program is displayed.

FIG. 4B is an example of a setting screen for setting application to start the electronic equipment 31 by the automatic start-up to perform automatic reception of mail in a manner as described above.

This setting screen is displayed also on, e.g., the LCD 17 of the video display module 12.

In this example, there is displayed setting of the automatic reception “ON” 43 of mail and the automatic stat-up 44 of “every each hour”.

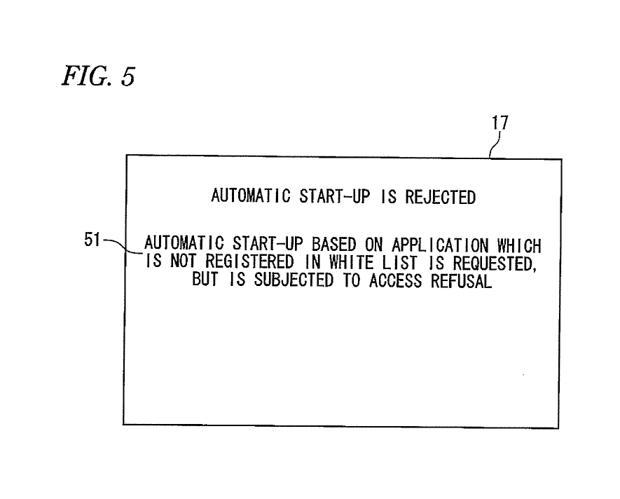

FIG. 5 is a diagram showing a display screen of automatic start-up refusal which is outputted from the electronic equipment according to the preferred embodiment.

In this embodiment, as described above, in the case where the above-mentioned application (the automatic start-up application) 32 is not an object of the “white list”, access to the application (automatic star-up application) 32 from the OS 33 is refused.

In this example, as shown in FIG. 5, there is outputted a display of the access refusal of “automatic starting is refused” and “automatic starting based on the application which is not registered within the white list is requested, but access refusal is performed”.

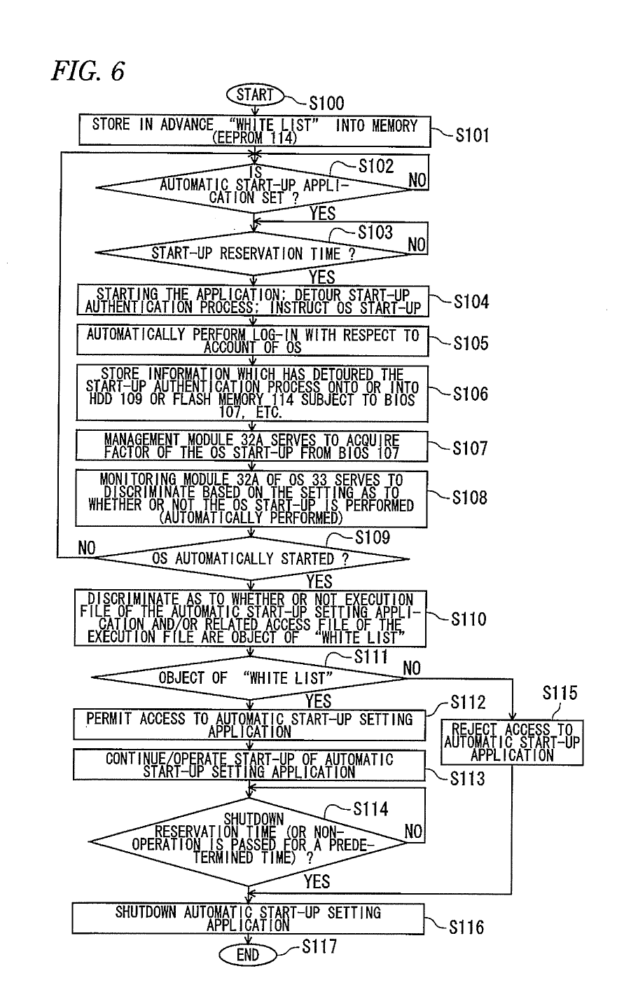

FIG. 6 is a flowchart for explaining the operation of the electronic equipment according to the preferred embodiment.

In this embodiment, in the case where start-up instruction of the OS33 is performed by the automatic stat-up application 32 (at the time of automatic stat-up operation), the stat-up authentication process of the OS 33 is detoured.

Further, there is performed such a process to store information indicating that the stat-up authentication process of the OS 33 is detoured onto or into HDD (storage module) 109 or flash memory subject to BIOS-ROM 107 (EEPROM114), etc.

Moreover, as described above, a monitoring module (monitoring filter) 33a is constituted in a portion (a predetermined layer) of the OS33.

Moreover, in this embodiment, this monitoring module (monitoring filter) 33a serves to discriminate as to whether or not the OS33 is started by the automatic start-up which has been set. Moreover, in the case where the OS33 is started by the automatic start-up, there is given such an instruction to refuse any access except for its execution file or the execution file and access files related thereto (e.g., file for mail box, etc.).

Further, the “white list” of the executable (accessible) files are stored onto or into the HDD (recording module) 109 or flash memory subject to BIOS-ROM 107 (EEPROM114), etc.

The step S100 is an initial step in this example. Subsequently, process proceeds to step S101.

The step S101 is a step of storing, in advance, the “white list” into the memory (EEPROM114, etc.) Subsequently, process proceeds to step S102.

The step S102 is a step of discriminating as to whether or not automatic start-up application like the above-mentioned automatic start-up application 32 is set. In the case where it is discriminated that the automatic start-up application is set, process proceeds to step S103 (Yes). In the case where it is discriminated that the automatic start-up application is not set, process in this step is repeated (No).

The step S103 is, e.g., a step of allowing the electronic equipment 31 to measure a time to discriminate as to whether or not the time thus measured reaches a start-up reservation time which is set by the automatic start-up application. In the case where it is discriminated that the measured time reaches the start-up reservation time which is set in the automatic application, process proceeds to step S104 (Yes). In the case where it is not discriminated that the measured time reaches a start-up reservation time which is set by the automatic start-up application, process in this step is repeated (No).

The step S104 is a step of starting the automatic start-up application to detour the start-up authentication process to instruct start-up of the OS33. Subsequently, process proceeds to step S105.

The step S105 is a step of automatically performing log-in with respect to account of the OS33. Subsequently, process proceeds to step S106.

The step S106 is a step of storing information indicating that the start-up authentication process is detoured onto or into the HDD 109 or flash memory 114 subjected by the OS107, etc. Subsequently, process proceeds to step S107.

The step S107 is a step of allowing the management module (filter) 32a to acquire factor started by the OS33 (e.g., the start-up which has been set, etc) from the BIOS 107. Subsequently, process proceeds to step S108.

The step S108 is a step of allowing the monitoring module 32a of the OS33 to detect as to whether or not start-up of the OS33 is performed (automatically started) based on above-mentioned setting by using the above-described factor. Subsequently, process proceeds to the a process S109.

The step S109 is a step of allowing the OS33 to discriminate that automatic start-up as described above is performed. In the case where it is discriminated that the automatic start-up as described above is performed, process by the OS33 proceeds to a step S110 (Yes). In the case where it is discriminated that the OS 33 is not automatically started automatic start-up as described above, process by the OS33 proceeds to a step S112 (Yes) to repeat above-mentioned processes. (No)

The step S110 is a step of detecting whether or not the execution file of the automatic start-up setting application (automatic start-up setting application) or the related access file of the execution file are an object of the above-mentioned “white list”. Subsequently, the process proceeds to a step S111.

The step S111 is a step of detecting whether or not the execution file of the automatic start-up setting application (automatic start-up setting application) or the related access file of the execution file are an object of the above-mentioned “white list”.

In the case where it is discriminated that the execution file of the automatic start-up setting application (automatic start-up setting application) or the related access file of the execution file are an object of the above-mentioned “white list”, process proceeds to step S112 (Yes). In the case where it is discriminated that the execution file of the automatic start-up setting application or the related access file of the execution file are not an object of the above-mentioned “white list”, process proceeds to step S115 (Yes).

The step S112 is a step of permitting the OS33 to provide an access to the above-mentioned automatic start-up setting application. Subsequently, process proceeds to a step S113.

The step S113 is a step of continuing start-up of the above-mentioned automatic start-up setting application to allow it to be executed. Subsequently, process proceeds to a step S114.

The step S114 is, e.g., a step of discriminating as to whether or not a corresponding time reaches a shutdown reservation time which is set in the automatic start-up setting application. As described above, the electronic equipment 31 can measure a time.

In the case where it is discriminated that a corresponding time reaches a shutdown reservation time which is set in the automatic start-up setting application, process proceeds to a step S116 (Yes). In the case where it is discriminated that a corresponding time does not reach a shutdown reservation time which is set in the automatic start-up setting application, process in this step is repeated (No).

It is to be noted although it is discriminated in the above-mentioned example that a corresponding time reaches a shutdown reservation time which is set in the automatic start-up setting application, there may be employed, in this embodiment, e.g., a configuration to measure a non-operational time of the electronic equipment 3 by user to discriminate whether or not such a non-operation time is passed in a predetermined time.

The step S115 is a step of giving an instruction to allow the OS33 to refuse access to the automatic start-up setting application. Subsequently, process proceeds to a step S116.

The step S116 is a step of shutting down the above-mentioned start-up setting application. Subsequently, process proceeds to step S117.

The step S117 is an end step, in which process in this step is completed.

By employing the above-mentioned configuration, even if such an automatic start-up as described above is performed in this embodiment, it becomes possible to ensure security.

Moreover, it becomes possible to prevent the operation of virus software and/or spyware, etc. at the time of the automatic start-up operation.

Further, also in the case where an owner of the electronic equipment (PC) 31 automatically starts the electronic equipment (PC) 31 when he is absent, e.g., it becomes possible to prevent unauthorized operation by the third party, etc.

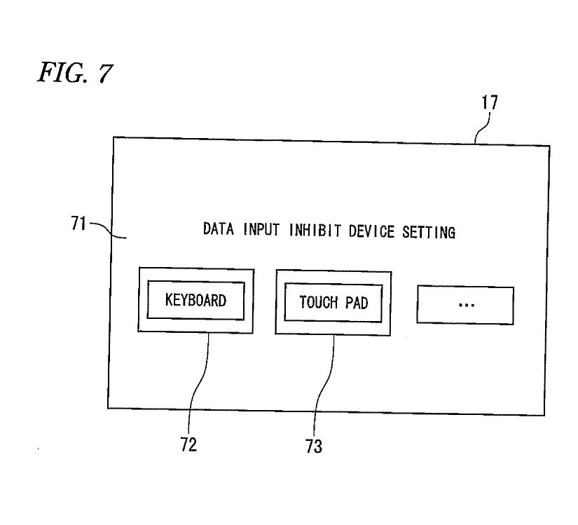

FIG. 7 is a diagram showing an example of a screen for a device to inhibit data input at the electronic equipment according to the preferred embodiment.

In this embodiment, for example, there may be set such a device to inhibit data input at the electronic equipment 31.

As shown in FIG. 7, for example, in a manner as described above, “setting of a device to inhibit data input” screen is displayed on the LCD 17 of the video display module 12.

Further, in this example, keyboard (KB) 72 and touch pad 73 are set as devices adapted for inhibiting data input.

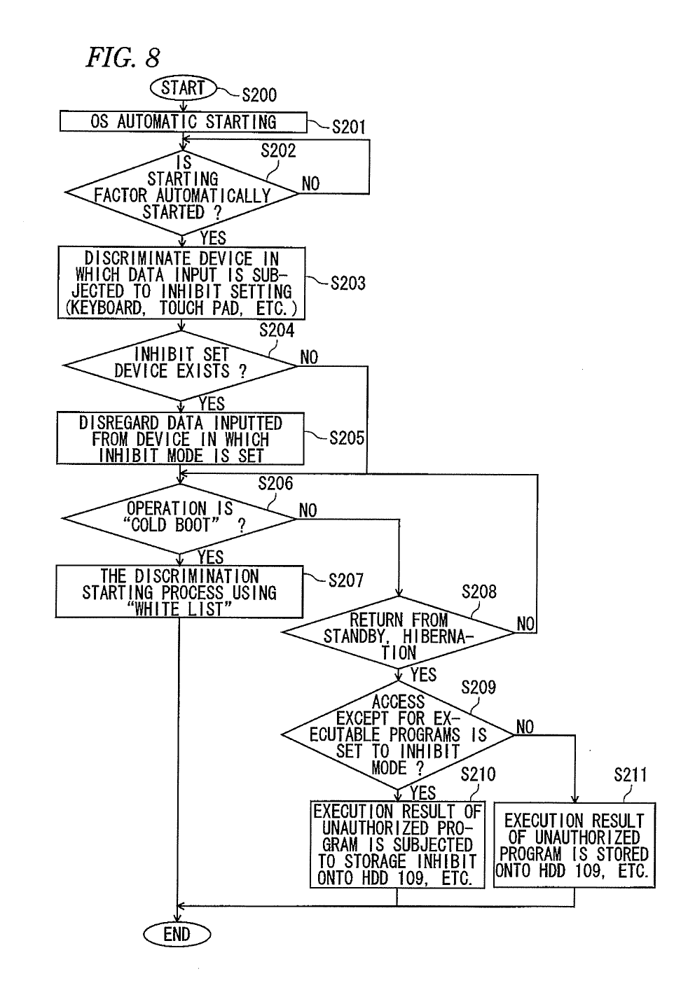

FIG. 8 is a flowchart for explaining another operation of the electronic equipment according to this embodiment.

A step S200 is a start step in this example. Subsequently, process proceeds to a step S201.

As described above, the step S201 is a step of automatically starting the OS33 (OS automatic start-up). Subsequently, process proceeds to a step S202.

The step S202 is a step of discriminating whether or not start-up factor of the OS automatic start-up is automatic starting. In the case where it is discriminated that the start-up factor of the OS automatic start-up is automatic start-up, process proceeds to a step S203 (Yes). In the case where it is discriminated that the start-up factor of the OS automatic start-up is not automatic start-up, processes in this step are repeated (No).

For example, as has been explained with reference to FIG. 7, the step S203 is a step of discriminating device such as keyboard and/or touch pad, etc. in which setting is made such that data input is inhibited. Subsequently, process proceeds to a step S204.

The step S204 is a step of discriminating as to whether or not there exists any device in which data input is inhibited. In the case where it is discriminated that there exists the device in which data input is inhibited, process proceeds to a step S205 (Yes). In the case where it is discriminated that there does not exist any device in which data input is inhibited, process proceeds to a step S206 (No).

The step S205 is a step of disregarding data inputted from the device in which the inhibit mode is set. Subsequently, process proceeds to the step S206.

The step S206 is a step of discriminating as to whether or not the start-up is “cold boot”. In the case where it is discriminated that the above-mentioned start-up is the “cold start”, process proceeds to a step S207 (Yes). In the case where it is not discriminated that the start-up is not discriminated as “cold boot”, process proceeds to a step S208 (No).

The “cold start” will now be described. In this embodiment, the “cold boot” refers to start-up from the state where the power supply of a computer is completely turned OFF. In this example, in the case of start-up, this case may refers to the “cold boot” or the “cold start”. In the case of restart, this case also refers to “cold reboot”, “cold restart”, or “cold reset”.

A step S208 is a step of discriminating as to whether or not the operating state of the computer is return from standby or hibernation, etc. In the case where it is discriminated that operating state of the computer is return from standby or hibernation, etc., process proceeds to the step S208 (Yes). In the case where it is discriminated that the operating state of the computer is not return from standby or hibernation, etc., process proceeds to step S206 to repeat the above-mentioned process (No).

The step S209 is a step of discriminating as to whether or not accesses except for the execution authorized program are set to inhibit mode. In the case where it is discriminated that the accesses except for the execution authorized program are set to inhibit mode, process proceeds to a step S210 (Yes). In the case where it is discriminated that the accesses except for the execution authorized program are not set to inhibit mode, process proceeds to a step S211 (No).

The step S210 is a step of inhibiting storage of execution result of the unauthorized program onto HDD109, etc. Subsequently, process proceeds to a step S212.

The step S211 is a step of storing execution result of the an authorized program onto the HDD 109, etc. Subsequently, process proceeds to a step S 212.

The step S212 is an end step, wherein process in this step is completed.

As described above, in this embodiment, there is employed such a scheme to make a setting to inhibit data input of predetermined devices (keyboard, touch pad, etc.) to have ability to inhibit user operation of a device in which data input is set to inhibit mode

Namely, in this embodiment, for example, user performs in advance the following settings.

User (administrator) of the electronic equipment (PC) 31 performs, e.g., setting of password of authentication at the time of start-up and registration of finger to be authenticated of the fingerprint authentication to allow the authentication at the time start-up to be valid.

Moreover, user serves to allow the automatic start-up to be valid to perform setting of the starting time (period) and to select a start-up authorized program from programs which have been installed with respect to the electronic equipment (PC) 31 to specify the selected program. Moreover, specifying operation of account to perform log-on at the time of log-in is also performed. In this example, in the case where the log-on password is required, user performs setting thereof.

Moreover, as described above, at the time of automatic start-up, there is provided such a setting capable of inhibiting input by the keyboard (KB) and mouse, etc.

Further, for example, start-up is performed in a manner described below.

In the case where the so-called ordinary start-up is performed by allowing the power supply of the electronic equipment (PC) 31, etc., to be turned ON so that the authentication which has been set is passed, process proceeds to start-up of OS 33, and log-on with respect to the OS account at times subsequent thereto.

Moreover, in the case of the above-mentioned automatic start-up, the BIOS 107 serves to automatically start the electronic equipment (PC) 31 when a corresponding time becomes equal to, e.g., the reserved time to store information indicating that such an automatic start-up has been performed into the storage region (a portion of the BIOS 107).

Further, at time of the automatic start-up, the start-up authorized authentication is detoured. Furthermore, process shifts to start-up of the OS 33 to automatically perform log-on also with respect to the account of the OS.

Further, during the operation of the OS 33, program for monitoring start-up which has been incorporated in the OS 33 serves to acquire start-up factor from the BIOS 107.

It is to be noted that in the case where start-up factor is not the above-mentioned automatic start-up, the above-mentioned process is not performed.

Moreover, in the case where the start-up factor is automatic start-up, when, e.g., input device inhibit is set during the automatic start-up in the UI (user interface), input data from those input inhibit setting devices are disregarded.

Further, confirmation is performed such that a file for which the execution request has been made is registered in the “white list”.

Further, in the case where the file for which the execution request has been made is not registered in the “white list”, the concerned file is refused.

Moreover, in the case where the above-mentioned automatic start-up is return from standby or hibernation in place of the cold boot, even if any unauthorized process being processed exists, no special process is not performed.

It should be noted that even when user sets inhibit of access except for files and or folders which are accessed by the execution authorized program, even if the operation of any authorized program can be performed on the CPU 101 and the main memory 101, it is impossible to store its result into the storage module such as HDD 109, etc.

Further, as described above, if a corresponding time reaches a reserved time (a specified time after automatic start-up) by setting of automatic start-up, the electronic equipment 31 is automatically shut down.

Alternatively, in the case where a non-operation time is passed for a predetermined time at setting of power plan of the OS 33, if shutdown time is automatically passed, shift to shutdown (or standby, hibernation) may be performed.

Namely, in this embodiment, the electronic equipment 31 has application for instructing OS 33 to start based on the above-mentioned setting.

Moreover, there is made a discrimination as to whether or not the OS 33 is started based on instruction of start-up of application.

Moreover, in the case where the OS 33 is started based on the instruction to start the application, discrimination is made as to whether or not the application is an object of the “while list” stored in advance, whereby when the application is not the “white list”, there is given an instruction to refuse access to the application from the OS 33.

Moreover, in the case where instruction of the starting of the OS33 is performed, the starting authentication process is detoured.

Further, in the case where the application is an object of the “white list”, start-up of the application is continued.

Further, in the case where the application is an object of the “white list”, access to the application from the OS33 is permitted.

Further, in the case where the OS is started based on start-up instruction of the application, there is performed a discrimination as to whether or not the execution file of the application and/or file related to the execution file are objects of the “white list”.

Further, the electronic equipment 31 comprises an output module for outputting access rejection.

Further, the electronic equipment 31 comprises an inhibit device setting module capable of setting a device to inhibit data input at the electronic equipment.

By employing a configuration as described above, it is possible to reduce troublesomeness that user feels to improve convenience of the electronic equipment in this embodiment.

It is to be noted that the procedure of the control process of the above-described embodiment may be executed all by software. For this reason, this program may be installed into an ordinary computer through a computer readable storage medium in which programs for executing the procedure of the control process are stored to only execute those programs, thereby making it possible to easily realize effects/advantages similar to those of the preferred embodiment.

It should be noted that the above-described embodiments are not limited to the description itself, but may be embodied with respective components being variously modified or changed within the scope which does not depart from the gist thereof at the stage of the implementation.

In addition, a suitable combination of a plurality of components disclosed in the above-described preferred embodiment may be performed to thereby have ability to form various inventions.

For example, several components may be omitted from all components disclosed in the preferred embodiments. Further, components ranging over different embodiments may be combined as occasion demands.

What is claimed is:

1. An electronic equipment comprising:
an application configured to operate an electronic equipment, which serves to instruct OS to start based on settings;
an OS starting discriminating module configured to discriminate as to whether or not the OS is started based on instruction of start-up of the application; and
a white list object discriminating module configured to discriminate whether or not the application is an object of the white list stored in advance when the OS is started based on instruction of start-up of the application, and configured to instruct refusal of access of the application from the OS when the application is not the object of the white list.

2. The electronic equipment according to claim 1, wherein
when the OS start-up instruction is performed, start-up authentication process of the OS is detoured.

3. The electronic equipment according to claim 1, wherein
when the application is an object of the white list, start-up of the application is continued.

4. The electronic equipment according to claim 1, wherein
when the application is an object of the white list, an access to the application from the OS is permitted.

5. The electronic equipment according to claim 1, wherein
when the OS is started based on instruction of start-up of the application, there is performed a discrimination such that an execution file of the application and/or file related to the execution file are an object of the white list.

6. The electronic equipment according to claim 1, further comprising:
an output module configured to output refusal of the access.

7. The electronic equipment according to claim 1, further comprising:
an inhibit device setting module configured to set a device in which data input to the electronic equipment is inhibited.

8. A method of controlling an electronic equipment comprising:
allowing an application for operating an electronic equipment to instruct OS to start based on settings;
discriminating as to whether or not the OS is started based on instruction of starting of the application; and
discriminating as to whether or not the application is an object of a white list stored in advance when the OS is started based on instruction of start-up of the application; and
instructing refusal of access of the application from the OS when the application is not the object of the white list.

9. A control program for an electronic equipment operative to allow the electronic equipment to execute:
allowing an application for operating the electronic equipment to instruct OS to start based on settings;
discriminating as to whether or not the OS is started based on instruction of start-up of the application;
discriminating as to whether or not the application is an object of a white list stored in advance when the OS is started based on instruction of starting of the application; and
instructing refusal of access of the application from the OS when the application is not the object of the white list.
